(19) United States
(12) Patent Application Publication
(10) Pub. No.: US 2016/0023956 A1
(43) Pub. Date: Jan. 28, 2016

(54) CERAMIC-CERAMIC WELDS

(71) Applicant: The Curators of the University of Missouri, Columbia, MO (US)

(72) Inventors: Gregory Eugene Hilmas, Rolla, MO (US); William Gene Fahrenholtz, Rolla, MO (US); Jeremy Lee Watts, Rolla, MO (US); Derek Scott King, St. James, MO (US); Sean Landwehr, Avon, IN (US)

(21) Appl. No.: 14/444,409

(22) Filed: Jul. 28, 2014

(51) Int. Cl. C04B 37/00; C04B 35/565

(52) U.S. Cl. CPC C04B 37/003; C04B 35/565; C04B 37/005

(57) ABSTRACT

A method of producing a ceramic weld, including identifying a ceramic first surface and a ceramic second surface to be bonded together, maintaining a non-oxidizing atmosphere over the first and second surfaces, and engaging the first and second surfaces to define a joint. An arc is generated between an electrode and the joint to create a liquid phase, and the liquid phase is cooled to yield a solid fusion layer, wherein the first and second surfaces are joined in the fusion layer.

### TECHNICAL FIELD

The present novel technology relates generally to the field of materials science and, more particularly, to a method for welding ceramic bodies together.

### BACKGROUND

Ceramics are inherently brittle materials. While very strong under compression, ceramic materials are typically weak under tension and torsional stresses. Thus, while ceramic materials generally exhibit high elastic moduli values, they are prone to brittle fracture and thermal shock.

Ceramic materials are typically joined together through the application of a cement at the interface between two bodies. While this technique works well for joining two ceramic materials together, it is less useful for joining a ceramic to another material, such as a structural metal body, that has a substantially different coefficient of thermal expansion. Further, cements are less useful for joining materials that will experience significant tension or flexure, since cements are also prone to brittle fracture.

Further, as-formed ceramic bodies are typically limited to simple shapes, both because it is difficult to cast or form ceramic materials directly into complex shapes and it is equally difficult to machine brittle bodies into complex shapes after they are formed. Attempts have been made to produce ceramic bodies having complex shapes, such as by cementing or otherwise fastening the simple bodies together. Only limited success has been achieved to date using cements, due to their likewise inherent brittleness. Glues likewise do not offer sufficient bond strength to connect ceramics into more complex shapes. The use of fasteners, such as screws or bolts, is likewise limited because drilling holes through brittle ceramics introduces cracks that act as stress concentrators, thus giving rise to failure mechanisms in the ceramic bodies. Further, the fasteners themselves become focal points for stress concentration.

Welding ceramic bodies to themselves or to non-ceramics has thus far met with little success. The welding process typically includes the application of heat to the ceramic, thus introducing microcracks through thermal shock. Such ceramic welds have been hard to form, and those that have been formed have had very low bond strength.

Thus, there remains a need for a method of welding ceramic bodies together and/or to non-ceramic bodies, without experiencing detrimental thermal shock or other damage at and around the weld site. The present invention addresses this need.

### SUMMARY

The present novel technology relates generally to materials science. One object of the present novel technology is to provide an improved method of joining two ceramic bodies. Related objects and advantages will be apparent from the following description.

### BRIEF DESCRIPTION OF THE DRAWINGS

FIG. 1 is a diagrammatic view of a ceramic to ceramic welding method according to one embodiment of the present novel technology.

FIG. 2 is a photomicrograph of a welded body including two SiC pieces joined with a fusion weld according to the embodiment of FIG. 9.

### DETAILED DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

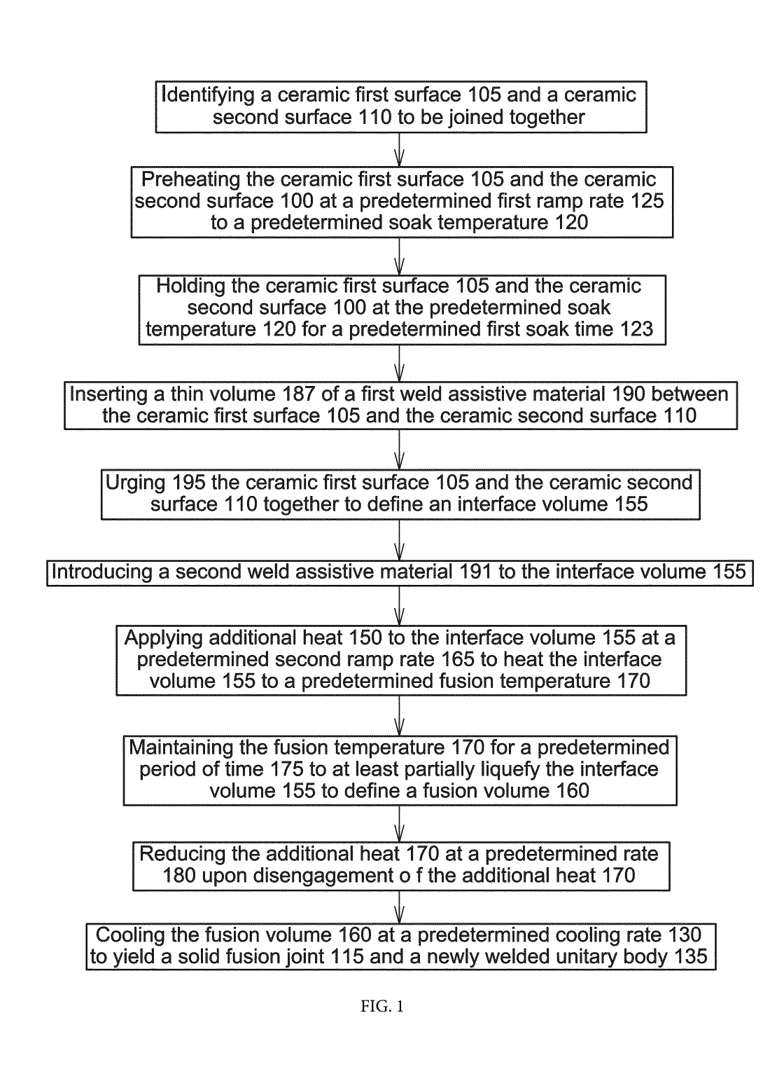

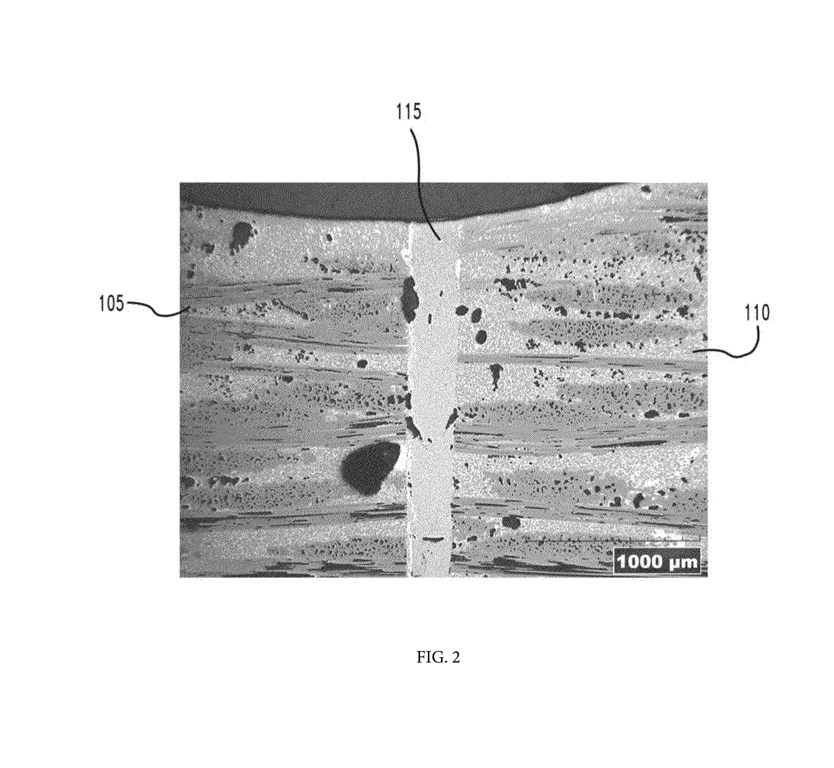

FIGS. 1-2 illustrate a first embodiment of the present novel technology, a method for joining electrically conductive ceramics and ceramic composites by arc welding 10. Ceramics are inherently brittle materials that are susceptible to thermal shock during the rapid heating and cooling cycles encountered during fusion welding. The application of properly selected preheat and postheat treatments enables the joining of conductive ceramics and ceramic composites to themselves as well as to metal structures. The novel joining process enables the joining of components of varied size from hot pressed, PVD, sputtered, CVD, plasma deposited, arc cast, sintered, and the like, ceramics, cermets, and ceramic matrix composites. Ceramic welding enables the production of large, complex compound forms 20 from precursor bodies having the simple shapes that are common of sintered and hot pressed ceramics , while retaining the strength and toughness inherent in the starting materials. The novel welding process can produce joints that exhibit the same thermophysical and mechanical behavior as the parent material. In addition, arc welded joints are able to withstand the same chemically corrosive, oxidizing atmospheres, and high temperature environments as the materials of the parent bodies.

Some potential uses include joining of thermal protection systems (TPS) to structural components, producing exotic thermocouples, repairing and producing hybrid ballistic armor systems, joining of wear resistant or heat resistant surfaces to load bearing components such as those found in engines (internal combustion, Stirling, and turbine), joining refractory solar-absorptive ceramic surfaces to structural components for concentrated solar thermal applications, joining of wear resistant components to refractory alloys to produce bearings for high temperature applications (>1000° C.), and the like. Ceramic welding enables the production of complex shapes from simple hot pressed and sintered shapes. The precursor bodies are typically nearly theoretically dense, more typically at least about 98% dense (no more than 2% porosity), still more typically at least 99% dense (no more than 1% porous), yet more typically at least 99.5% dense (no more than 0.5% porosity), and still more typically at least about 99.9% dense no more than 0.1% porosity). The ability to weld simple shapes into more complex structures reduces machining costs and decreases the time required to achieve a finished component. In some cases, ceramic welding is useful for improving mechanical behavior by refining grain sizes and producing thermodynamically stable grain boundaries which form from the melt in the joint region. Ceramic welding also enables the repair of ceramic components and composite structures.

Ceramics generally exhibit high elastic moduli values and are susceptible to brittle fracture and thermal shock. In order to minimize mechanical failure arising from thermal shock of large components during the fusion welding process, the precursors are subjected to a preheating thermal profile and the compound structures so formed are subjected to a post-welding thermal profile, as, in general, ceramic materials lack the sufficiently high thermal shock resistance and/or significant ductility below the system's melting temperature to avoid material failure from thermal shock. Alternately, the properties of the precursor pieces may be tailored to have very low coefficients of thermal expansion and/or sufficiently high ductility to offer superior thermal shock resistance. The temperature and duration of pre- and post-heating treatments are different for each material. In order to predetermine the pre-heat and the post-weld profiles, the minimum temperatures required to plastically relieve stresses are investigated. Each ceramic, ceramic particle composite, ceramic matrix composite, or cermet system is characterized by its ability to relieve stresses that accumulate during the novel welding process. Processes lending to stress relief at high temperature include microcracking, grain boundary sliding or softening, dislocation motion, twinning, grain growth, recrystallization, combinations thereof, and the like. The pre- and post-heat treatment profiles are influenced by the temperatures at which appreciable stress relief occur by the aforementioned mechanisms.

In general, dislocation motion, twinning, grain growth and recrystallization occur at or above a homologous temperature (T_{H}=T/Tₘ) of T_{H}≈0.4-0.5. For materials exhibiting grain boundary softening, microcracking, and grain boundary sliding, the pre- and post-heat treatment temperature will be largely influenced by precursor body composition and material processing before welding. To minimize the variability of the high temperature plasticity found in ceramics, it may be useful to conduct characterization (such as mechanical testing, neutron or x-ray diffraction, or the like) studies of the materials to be welded at high temperature prior to welding to identify the proper pre- and post-heat conditions for the specific component bodies. These studies will be unnecessary if it is possible to conduct welding trials and/or if plastic deformation occurs at temperature slightly above T_{H}≈0.4-0.5.

In general, large component bodies are preheated to higher temperatures to prevent warping and cracking. More typically, for larger precursor bodies lower heating and cooling ramp rates are chosen for the preheat and post-weld thermal profiles. Further, conductive ceramics often are susceptible to oxidation at high temperature, so conductive ceramic precursor bodies are typically shielded from oxidizing conditions at elevated temperatures in order to preserve the integrity of the component.

FIGS. 1-2 illustrate one embodiment of the present novel technology, a method 100 for joining two (typically compositionally similar) ceramic surfaces 105, 110 in a weld or fusion bond 115. As ceramics are inherently brittle materials and as such are susceptible to thermal shock damage during the rapid heating and cooling cycles, the surfaces 105, 110 are typically preheated to a first elevated soak temperature 120 and held there for a first soak time 123. The first ramp rate 125 from ambient to the first elevated soak temperature 120 is typically slow enough so as to avoid or minimize thermal shock damage. Likewise, a post welding slow ramp down to ambient temperature at a second slow ramp rate 130 is typically employed to minimize thermal shock damage to the newly welded piece 135 and the newly formed joint 115. The application of properly selected preheat and postheat treatments assists in the joining of ceramic surfaces 105, 110.

Once the surfaces 105, 110 are at the first soak temperature 120, the surfaces are urged together to define an interface volume 155 therebetween and additional heat 150, such as from a plasma torch or the like, is applied at the interface volume 155 between the surfaces 105, 110 to form an at least partially liquefied fusion volume 160, which is then cooled (typically at a predetermined cooling rate 161 to a predetermined end temperature 163) to define a fusion joint 115. More typically, the cooling rate 161 is sufficient to anneal the fusion joint 115 and adjacent surfaces 105, 110 of thermally induced stresses. The additional heat 150 is sufficient to liquefy the fusion volume 160 but is not sufficiently great and/or of such duration to significantly decompose the ceramic surfaces 105, 110. Typically, the additional heat 150 is quickly ramped up at a first welding heat ramp rate 165 to a nominal welding level 170, held at the nominal welding level 170 for a predetermined second soak time 175, and ramped down at a second welding rate 180 upon disengagement.

Depending on the composition of the surfaces 105, 110, the first soak temperature 120 may be from about 700 degrees Celsius to about 1100 degrees Celsius and the additional heat 150 may be represented by a welding current of between about 25 Amperes and 75 Amperes with a duration 155 of between about 5 seconds and about 20 seconds. In other words, depending on the composition of the surfaces 105, 110, the first soak temperature 120 may be from about 700 degrees Celsius to about 1500 degrees Celsius and the additional heat 150 may result in final, near surface temperature of 1400 degrees Celsius to 3500 degrees Celsius with a duration 155 of between about 5 seconds and about 20 seconds for spot welds or short (1-2 cm.) linear welds, and longer for longer linear welds.

The novel joining process 100 enables the production of large, complex compound bodies 135 from precursor surfaces 105, 110 having the simple shapes that are common of sintered and hot pressed ceramics, while retaining the compressive strength, toughness and chemical durability inherent in the starting materials. The novel welding process 100 can produce joints 115 that exhibit the same thermophysical and mechanical behavior as the parent material. In addition, the welded joints 115 are able to withstand the same chemically corrosive, oxidizing atmospheres, and high temperature environments as the materials of the parent surfaces 105, 110.

During the welding process 100, some material decomposition may occur and it may be advantageous to provide a thin volume 187 of filler or additive material 190 at the interface 155 having a composition that may offset or otherwise minimize the thermal decomposition effects. The filler or additive material 190 may have the same composition as one or both surfaces 105, 110, the composition of one of the constituents of one or both surfaces 105, 110, or a different composition compatible with one or both surfaces 105, 100 so as to strengthen the joint 115. The thin volume 187 of additive material 191 is typically provided as a pressed sheet or the like, more typically having homogeneous and predetermined thickness and composition. Typically, a second weld assistive material 191 may be added to react with the surfaces 105, 110 and/or the first weld assistive material 190 while the fusion volume 160 is at least partially liquefied. The second additive material 191 is typically introduced to the interface 155 as a powder, or as a separate pressed film or sheet, or as a constituent of the pressed sheet introducing the first weld assistive material 190. Thus, the joint 115 may be compositionally the same or similar to that of the surfaces 105, 110 or it may be different yet compatible with the surfaces 105, 110.

Weld quality may likewise be improved by providing an urging force 195 on the surfaces 105, 110 in the direction of the interface 155 in order to minimize drift or widening of the joint 115 during welding 100.

Weld quality may also be improved by selection of an appropriate atmosphere that may retard thermal degradation of the surfaces 105, 110 and/or the weld 115, for example an oxidizing atmosphere for oxide ceramics or a nonreactive or reducing atmosphere for carbide or nitride ceramics.

The welding technique 100 may be performed as a spot weld, or may be a linear weld accomplished by moving the source of additional heat 150 along the interface 155, typically at a predetermined rate.

Ceramic welding 100 enables the production of bodies 135 having complex shapes from simply shaped precursor surfaces 105, 110. The precursor surfaces 105, 110 are typically nearly theoretically dense, more typically at least about 98% dense (no more than 2% porosity), still more typically at least 99% dense (no more than 1% porous), yet more typically at least 99.5% dense (no more than 0.5% porosity), and still more typically at least about 99.9% dense no more than 0.1% porosity). The ability to weld 100 simple surfaces 105, 110 into more complex structures 135 reduces machining costs and decreases the time required to achieve a finished component 135. In some cases, ceramic welding 100 is useful for improving mechanical behavior by refining grain sizes and producing thermodynamically stable grain boundaries which form from the melt in the joint region 115. Ceramic welding 100 also enables the repair of ceramic components and composite structures.

In operation, ceramic welding 100 may be accomplished by first identifying 200 a ceramic first surface 105 and a ceramic second surface 110 to be joined together and then preheating 205 the ceramic first surface 105 and the ceramic second surface 100 at a predetermined first ramp rate 125 to a predetermined soak temperature 120. Next the ceramic first surface 105 and the ceramic second surface 100 are held 210 at the predetermined soak temperature 120 for a predetermined first soak time 123, and a thin volume 187 of a first weld assistive material 190 is inserted 215 between the ceramic first surface 105 and the ceramic second surface 110. Next, the ceramic first surface 105 and the ceramic second surface 110 are urged 195 together to define an interface volume 155.

A second weld assistive material 191 is introduced 220 to the interface volume 155, and additional heat 150 is applied 225 to the interface volume 155 at a predetermined second ramp rate 165 to heat the interface volume 155 to a predetermined fusion temperature 170. A fusion temperature 170 is maintained 230 for a predetermined period of time 175 to at least partially liquefy the interface volume 155 to define a fusion volume 160, and then the additional heat 170 is reduced 235 at a predetermined rate 180 upon disengagement o f the additional heat 170. The final step is cooling 240 the fusion volume 160 at a predetermined cooling rate 130 to yield a solid fusion joint 115 and a newly welded unitary body 135.

### EXAMPLE 1

Two SiC ceramic surfaces 105, 110 were positioned adjacent one another to define an interface 155. The surfaces 105, 110 were heated at a rate 125 of about two (2) degrees Celsius per minute and maintained at a first soak temperature 120 of about one-thousand (1000) degrees Celsius. A first carbon additive material in the form of a ten mil thick pressed carbon sheet 190 was inserted into the interface volume 155 and a second additive material 190 was added to the surface of the surfaces 105, 110 adjacent the interface 155 so as to wick into the interface 155 during welding. The surfaces 105, 110 were clamped together to provide urging force 195 during welding 100. Additional heat 155 was applied plasma welding torch current, ramped up to 55 amps at a rate 165 of five (5) Amps per second from a pilot arc of twenty-five (25) Amps to a welding current 170 of fifty-five (55) Amps and maintained for a duration 175 of ten (10) seconds, followed by a five (5) second ramp down 180 to yield an at least partially liquid fusion volume 160. The fusion volume was cooled at a rate 161 of about 2 degrees Celsius per minute until it reached a predetermined end temperature 163 at which point the fusion volume 160 had solidified to yield a joint 115.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A method of welding two ceramic bodies together, comprising the steps of:
a) identifying a ceramic first surface and a ceramic second surface to be joined together;
b) preheating the ceramic first surface and the ceramic second surface at a predetermined first ramp rate to a predetermined soak temperature;
c) inserting a thin volume of a first weld assistive material between the ceramic first surface and the ceramic second surface;
d) urging the ceramic first surface and the ceramic second surface together to define an interface volume;
e) applying additional heat to the interface volume at a predetermined second ramp rate to heat the interface volume to a predetermined fusion temperature;
f) at least partially liquefying the interface volume to define a fusion volume; and
g) cooling the fusion volume at a predetermined cooling rate to yield a solid fusion joint;
wherein the first and second surfaces are melted together into the fusion joint.

2. The method of claim 1 wherein the ceramic second surface has the same composition as the ceramic first surface.

3. The method of claim 1 wherein the ceramic first surface and the ceramic second surface are both SiC.

4. The method of claim 3 wherein the first weld assistive material is a pressed carbon sheet.

5. The method of claim 1 and further comprising the step of h) after b) and before e), introducing a second weld assistive material to the interface volume.

6. The method of claim 4 wherein the first weld assistive material is a thin carbon sheet; second weld assistive material is silicon powder; wherein the ceramic first surface and the ceramic second surface are SiC; wherein the first ramp rate is about 2 degrees Celsius per minute; wherein the soak temperature is about 1000 degrees Celsius; and wherein the cooling rate is about 2 degrees Celsius per minute.

7. A method for fusion welding a ceramic body to another ceramic body comprising the steps of:
a) providing a first ceramic body having a first bonding surface and a second ceramic body having a second bonding surface to be welded together;
b) positioning the first bonding surface in contact with the second bonding surface to define an unwelded joint;
c) heating the first bonding surface to a temperature wherein T_{H} has a value of at least about 0.3;
d) electrothermally creating a liquid fusion zone at the joint having a thickness of at least about 0.5 centimeters; and
e) cooling the fusion zone sufficiently slowly to yield a solid welded joint;
wherein the solid welded joint is contiguous with the first and second ceramic bodies.

8. The method of claim 7 and further comprising f) after c) and before d), enveloping the respective bonding surfaces with a non-oxidizing atmosphere.

9. The method of claim 7 wherein the fusion weld shares the physical properties of both ceramic bodies.

10. The method of claim 7 wherein step f) includes following a cooling profile for relieving stress through mechanisms including microcracking, grain boundary sliding or softening, dislocation motion, twinning, grain growth, recrystallization, and combinations thereof.

11. The method of claim 7 wherein step c) includes heating the first bonding surface to a temperature wherein T_{H} has a value of between 0.4 and 0.5; and wherein step f) includes a prolonged isothermal soak near a temperature wherein T_{H} has a value of about 0.5.

12. A method of bonding two refractory bodies, comprising:
a) selecting a first refractory ceramic body having a first bonding surface;
b) selecting a second refractory body having a second bonding surface;
c) generating a non-oxidizing atmosphere over the first and second refractory bodies;
d) heating the bonding surfaces to a temperature wherein T_{H} has a value of at least about 0.3;
e) engaging the respective bonding surfaces together to define a joint interface; and
f) thermally establishing a molten fusion zone having a thickness of at least about 0.5 centimeters and contiguous with and between the first and second refractory bodies, joining the first refractory ceramic body to the second refractory ceramic body;
g) cooling the molten fusion zone to yield a fusion bond layer contiguous with the first and second refractory bodies; and
h) thermally relieving stress from the first and second refractory bodies and from the fusion bond layer.

13. A welded bond between a first ceramic body and a second ceramic body, comprising:
a first ceramic body surface;
a second ceramic body surface; and
an intermediate weld layer joining the first ceramic body and a second ceramic body;
wherein the first ceramic body surface and the second ceramic body surface are both composed of a first material composition;
wherein the intermediate weld layer has a second material composition similar to the first material composition.

14. The welded bond of claim 13 wherein the intermediate weld layer includes a plurality of discrete regions composed of constituent materials of the first material composition.

15. The welded bond of claim 13 wherein the first material composition is SIC and wherein at least one of the plurality of discrete regions is composed of silicon.

16. The welded bond of claim 13 wherein the first ceramic body surface, the second ceramic body surface, and the intermediate weld layer are substantially annealed of thermally induced stresses.
